(19) United States
(12) Patent Application Publication
(10) Pub. No.: US 2006/0204857 A1
(43) Pub. Date: Sep. 14, 2006

(54) High performance and safer electrolytes for lithium-ion electrochemical devices

(76) Inventors: Joseph B. Kejha, Meadowbrook, PA (US); Joel R. McCloskey, Philadelphia, PA (US); W. Novis Smith, Philadelphia, PA (US)

Correspondence Address: Zachary T Wobensmith III, 7746 101st Court, Vero Beach, FL, 32967-2871, US

(21) Appl. No.: 10/552,114

(22) PCT Filed: Apr. 17, 2003
(86) PCT No.: PCT/US03/12096

§ 371 Date: Oct. 4, 2005

(51) Int. Cl. C09K 21/06

(52) U.S. Cl. 429/330; 252/602

(57) ABSTRACT

Fire resistant stable electrolytes for use in lithium-ion based electrochemical devices, which include lithium salts in high molar concentration with various solvents, such as ethylene carbonate, and with a low % of butylene carbonate or propylene carbonate or gamma butyrolactone, and which devices may include a cathode with a lithium compound additive, and a graphitic anode.

### BACKGROUND OF THE INVENTION

1. Field of the Invention

This invention relates to fire resistant stable electrolytes for lithium-ion devices which have a low percent of high boiling point solvents in combination with ethylene carbonate and a high molar salt concentration. These electrolytes have similar performance characteristics as existing highly flammable electrolytes, and have a wider operating temperature span.

2. Description of the Prior Art

Prior art electrolytes that have high ionic conductivity(=high rate capability) are very flammable due to the inclusion of low boiling point flammable solvents such as dimethyl carbonate (DMC), diethyl carbonate (DEC), ethylmethyl carbonate (EMC), and dimethoxyethane (DME), or they have a low ionic conductivity due to the inclusion of high boiling point non-flammable glycol ethers, or they have a high percent (40% or more) of propylene carbonate (PC) or gamma-butyrolactone (GBL), which makes them non-competitive in performance in lithium-ion batteries with graphitic anodes, where the PC or GBL reacts with the anode, and causes a very high irreversible capacity loss, and a sharp decline in capacity during cycling. Examples of such prior art high boiling point electrolytes are described in the following patents and publications:

The article entitled “Polyacrylonitrile Electrolyte Based Li-ion Batteries” published in Electrochenical Acta (1998), 43 (16-17), 2399-2412 describes fire resistant polyacrylonitrile (pan) based electrolytes such as IM LiPF₆/EC/PC 50%, however this electrolyte does not have equal conductivity with flammable electrolytes and is in combination with a polymer.

The article entitled “PeoLike Polymer Electrolytes With High Room-Temperature Conductivity” published in the Journal of the Electrochemical society (1997), 144(6), Li36-Li38 describes fire resistant electrolytes such as IM LiPF₆/PEGDME, however, this electrolyte is less conductive than flammable electrolytes.

The U.S. Pat. No. 5,252,3413 of Alamgir et al. entitled “Solid Polymer Electrolyte Lithium Batteries” describes a fire resistant electrolyte IM LiCLCO₄/EC/PC 50% however it has less conductivity than flammable electrolytes and is in combination with a polymer.

The article entitled “Laminated Thin Li-ion Batteries Using a Liquid Electrolyte” published in the Journal of the Electrochemical Society, 149(1) A9-A12 (2002) describes a fire resistant electrolyte 1.5M LiBF₄/EC/GBL 75% or 1:3 ratio, which has a shorter cycle life and a higher capacity decline than flammable electrolytes.

The U.S. Pat. No. 6,280,881 of Wendsjo et al. entitled “Lithium Secondary Battery” describes a fire resistant electrolyte IM LiBF₄/EC/PC in a 1:1 or 50/50 ratio. This electrolyte does not have the narrow ratio range of EC, PC, or GBL or BC in combination with a polymer. This electrolyte is immobilized by a polymer.

Most of the prior art fire resistant electrolytes described above are one molar in lithium salt concentration, and they are in combination with a polymer. It should be noted, that although the individual salts or high boiling point liquids are known, what is not known is the optimum narrow ratio of solvents in combination with the molar content of the salts in the mixtures necessary to achieve an equivalent performance to liquid flammable (lower boiling point) electrolytes in lithium-ion, or lithium-ion-polymer batteries with graphitic anodes.

The combinations described produce fire resistant electrolytes (due to their high flash points and boiling points) that are useful in lithium-ion electrochemical devices, and provide many positive advantages over equivalent flammable electrolytes.

### SUMMARY OF THE INVENTION

It has now been found that safe fire resistant electrolytes for lithium-ion batteries are available, which electrolytes have high conductivity, minimal reactivity and good cycle life, and which can be made by using a lower percent of the high boiling solvent gamma-butyrolactone (GBL) in combination with ethylene carbonate (EC), and a high molar concentration (M) of the salt, such as 2M of lithium tetrafluoroborate (LiBF₄) salt, or a low percent of high boiling point solvents, such as propylene carbonate (PC) or butylene carbonate (BC) in combination with ethylene carbonate (EC), and a high molar concentration, such as 1.5M to 2M of lithium tetrafluoroborate salt, or their mixtures.

The principal object of the invention is to provide electrolytes for lithium-ion electrochemical devices that have good ionic conductivity and are fire resistant.

A further object of the invention is to provide electrolytes of the character aforesaid, which provide improved cycling stability for the electrochemical devices in which they are incorporated.

A further object of the invention is to provide electrolytes of the character aforesaid which are useful in a variety of electrochemical devices, such as automotive and military batteries, and capacitors.

A further object of the invention is to provide electrolytes of the character aforesaid which are particularly suitable for mass production.

Other objects and advantageous features of the invention will be apparent from the description and claims.

### DESCRIPTION OF THE DRAWINGS

The nature and characteristic features of the invention will be more readily understood from the following description taken in connection with the accompanying drawings forming part hereof in which:

FIG. 1 is a graph of voltage versus time of a prior art flammable electrolyte in a lithium-ion electrochemical device having the composition 1M LiPF₆/EC/DMC/EMC(1:1:1);

FIG. 1A is a graph illustrating capacity versus cycles of the device with the electrolyte therein of FIG. 1;

FIG. 2 is a graph of voltage versus time of an identical electrochemical device as in FIG. 1, incorporating an electrolyte of the invention of the composition 2M LiBF₄/EC/GBL 20%;

FIG. 2A is a graph illustrating capacity versus cycles of the device with the electrolyte therein of FIG. 2;

FIG. 3 is a graph of voltage versus tine of prior art fire resistant electrolyte in an identical electrochemical device as in FIG. 1, having therein the composition 1.5M LiBF4/EC/GBL 75%;

FIG. 3A is a graph illustrating capacity versus cycles of the device with the electrolyte therein of FIG. 3;

FIG. 4 is a graph of voltage versus time of an identical electrochemical device as in FIG. 1, incorporating an electrolyte of the invention of the composition 1.5M LiBF₄/EC/PC 20%;

FIG. 4A is a graph illustrating capacity versus cycles of the device with the electrolyte therein of FIG. 4;

FIG. 5 is a graph of voltage versus tine of a prior art fire resistant electrolyte in an identical electrochemical device as in FIG. 1, having the composition 1M LiBF₄/EC/PC 50%;

FIG. 6 is a chart of the conductivity of the electrolytes of FIGS. 2 and 2A, for a temperature span of −25° C. to 70° C., and

FIG. 7 is a chart of the conductivity of the electrolytes of FIGS. 4 and 4A, for a temperature span of −25° C. to 70° C.

It should, of course, be understood that the description and drawings herein are merely illustrative and that various modifications and changes can be made in the compositions disclosed without departing from the spirit of the invention.

### DESCRIPTION OF THE PREFERRED EMBODIMENTS

When referring to the preferred embodiments, certain terminology will be utilized for the sake of clarity. Use of such terminology is intended to encompass not only the described embodiments, but also technical equivalents which operate and function in substantially the same way to bring about the same result.

An electrochemical device of the lithium-ion variety, such as a lithium-ion cell (not shown) typically includes an anode, and a current collector in contact with the anode, a cathode and current collector in contact with the cathode, a separator and an electrolyte in contact with the anode and cathode, with the whole assembly contained in a moisture proof enclosure with exiting sealed terminals.

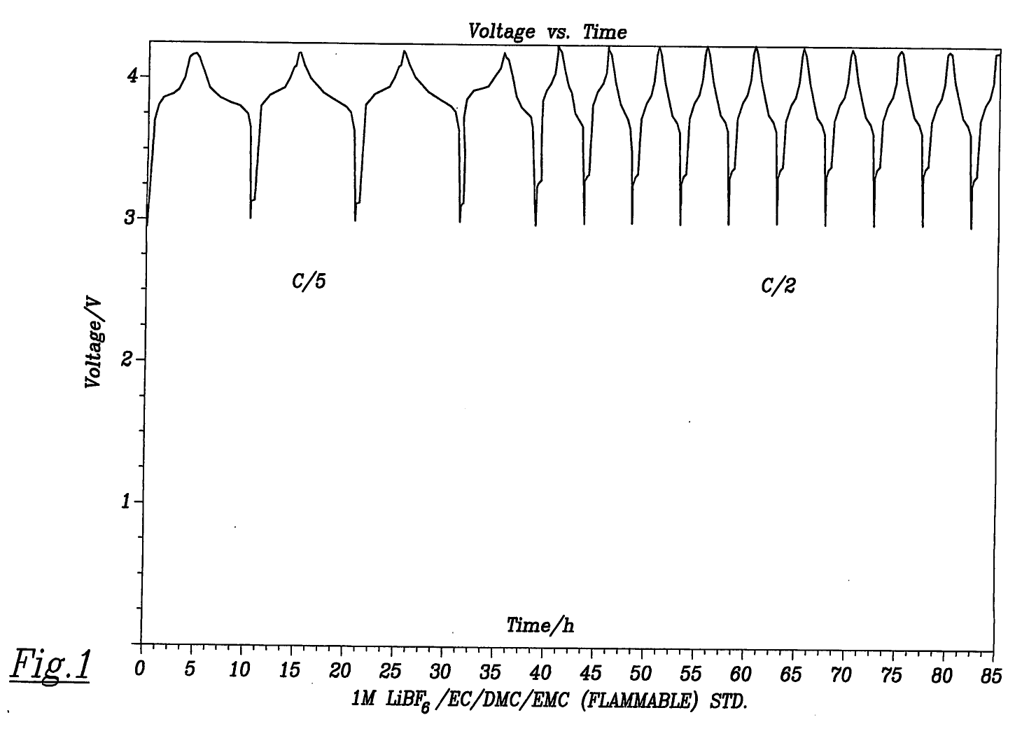

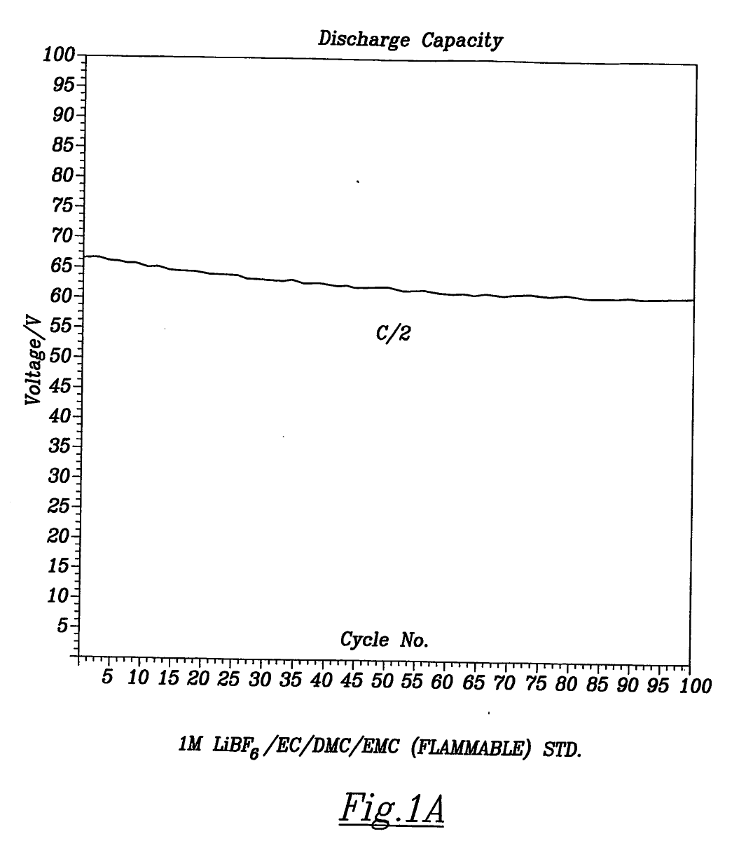

Referring to FIGS. 1 and 1A, the results obtained with a prior art electrolyte in a lithium-ion electrochemical device are illustrated, where the composition of the electrolyte is 1M LiPF₆/EC/DMC/EMC(1:1:1), and while it provides good performance the composition is highly flammable.

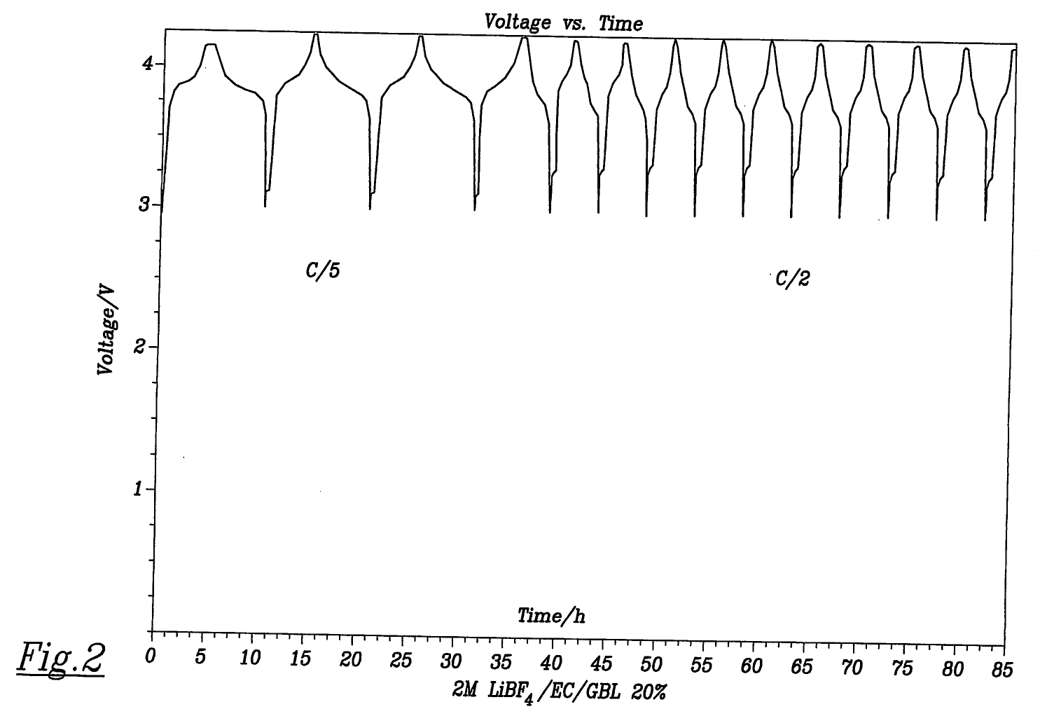

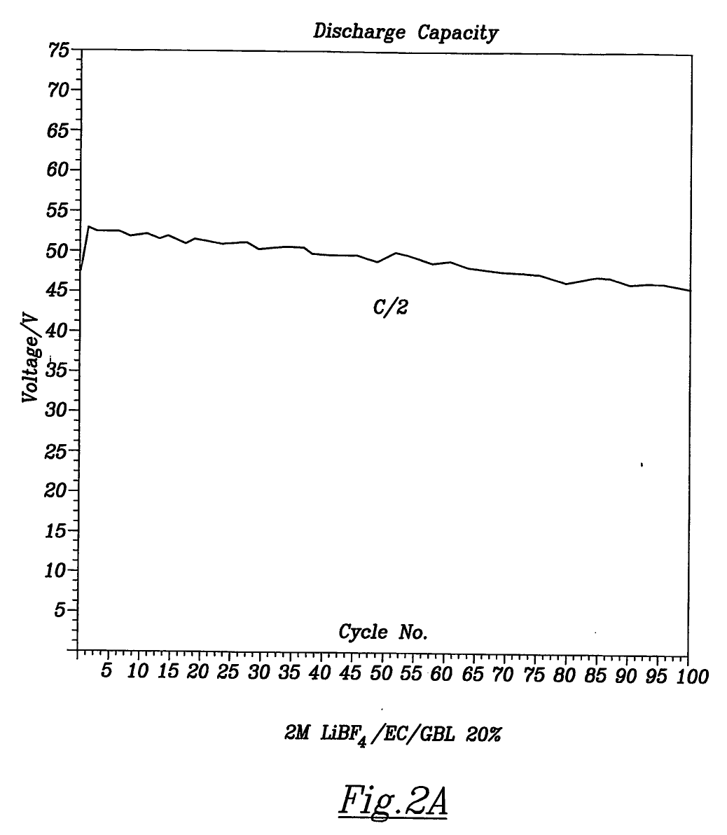

Referring to FIGS. 2 and 2A results are illustrated which were obtained with an electrolyte prepared in accordance with the invention, in a lithium-ion electrochemical device, with mesocarbon microbeads (MCMB) or boron coated graphite fiber anodes.

The electrolyte of the invention contained 2M LiBF₄ salt in an EC/GBL 20% mixture (or 4:1 ratio) and provided similar performance as the prior art electrolyte of FIGS. 1, 1A in rate capability, and cycle life, as well as capacity decline at C/2 rate.

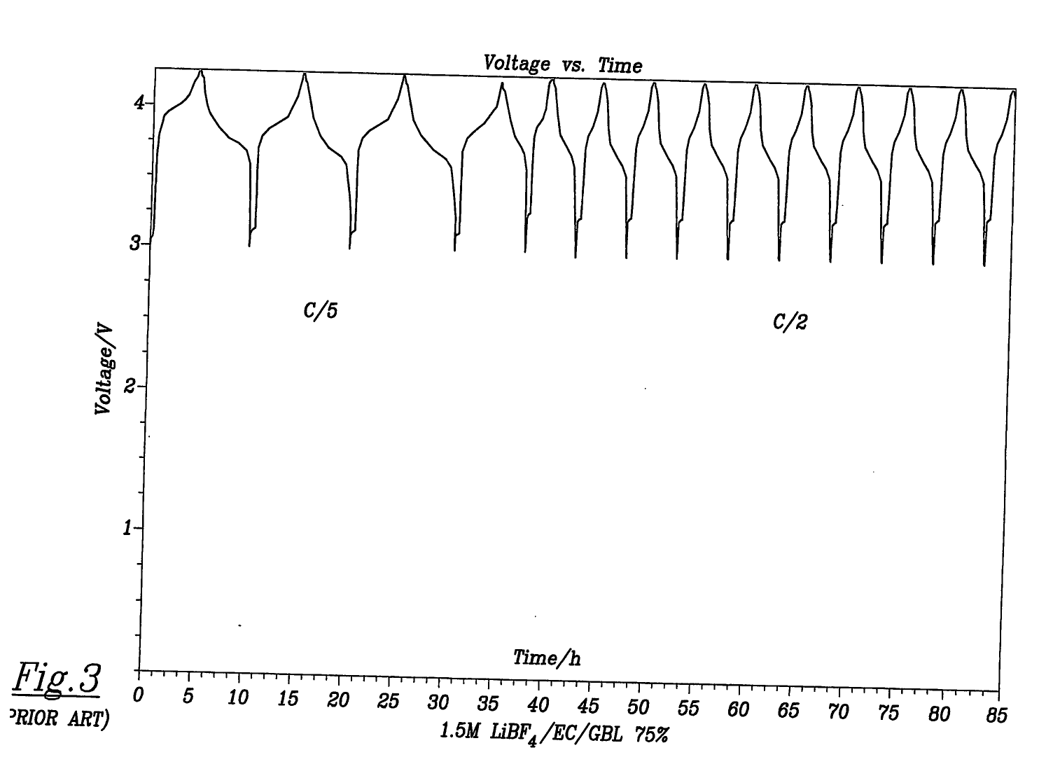

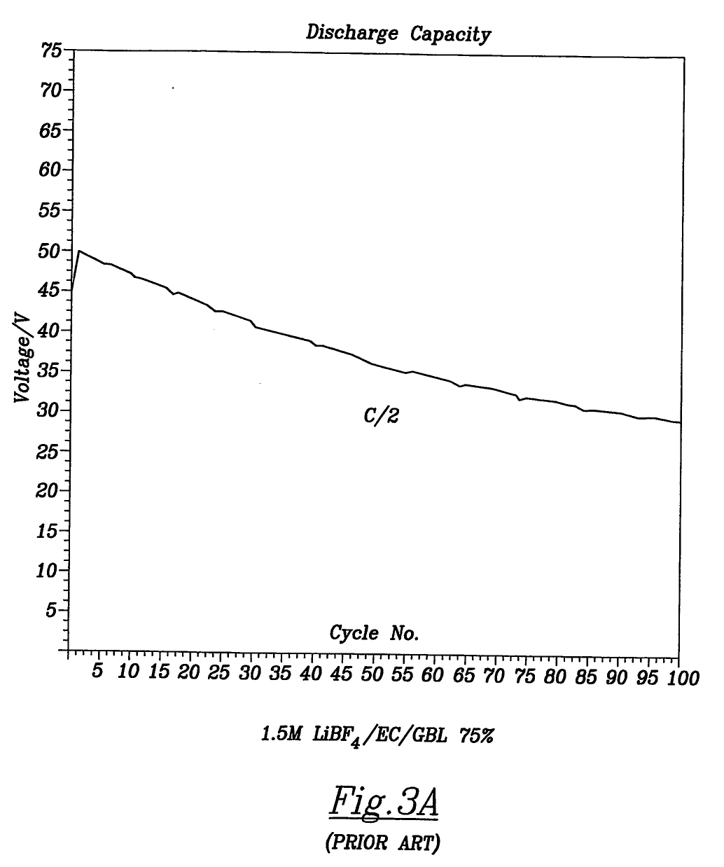

Referring to FIGS. 3 and 3A the results obtained with a prior art fire resistant electrolyte electrochemical device are illustrated.

The composition of FIGS. 3, 3A was 1.5M LiBF₄/EC/GBL 75% in a lithium-ion cell, with mesocarbon microbeads (MCMB), or boron coated graphite fiber anodes. The results obtained when compared to FIGS. 2 and 2A show that the composition of the invention (FIGS. 2 & 2A) outperformed the prior art electrolyte (FIGS. 3, 3A) in less capacity decline at C/2 rate.

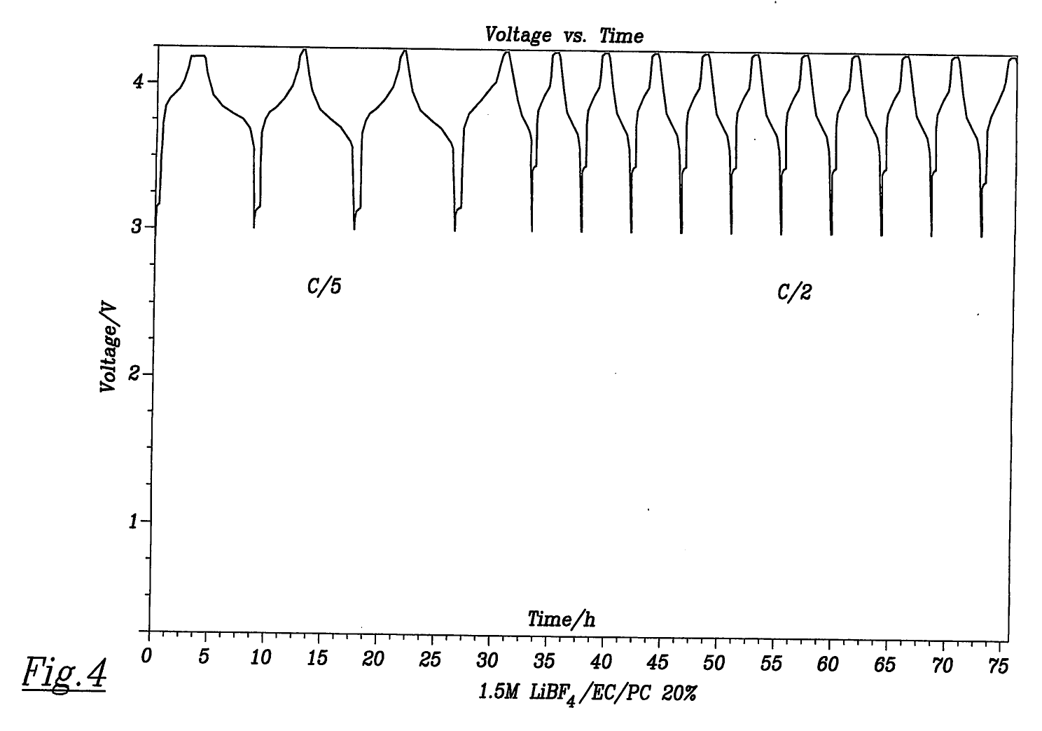

Referring to FIGS. 4, 4A the results obtained with another electrolyte composition prepared in accordance with the invention in a lithium-ion electrochemical device are illustrated.

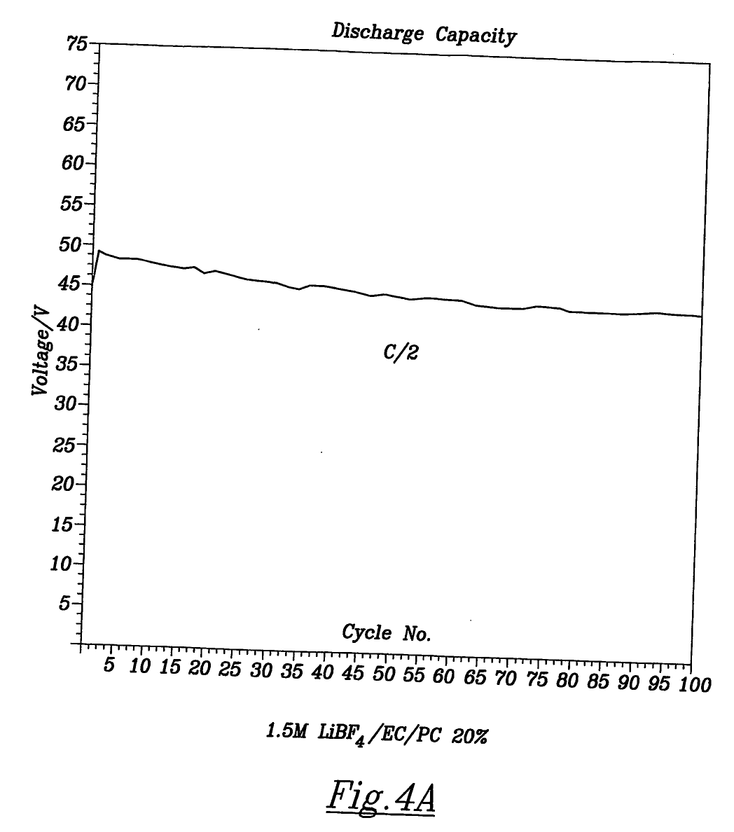

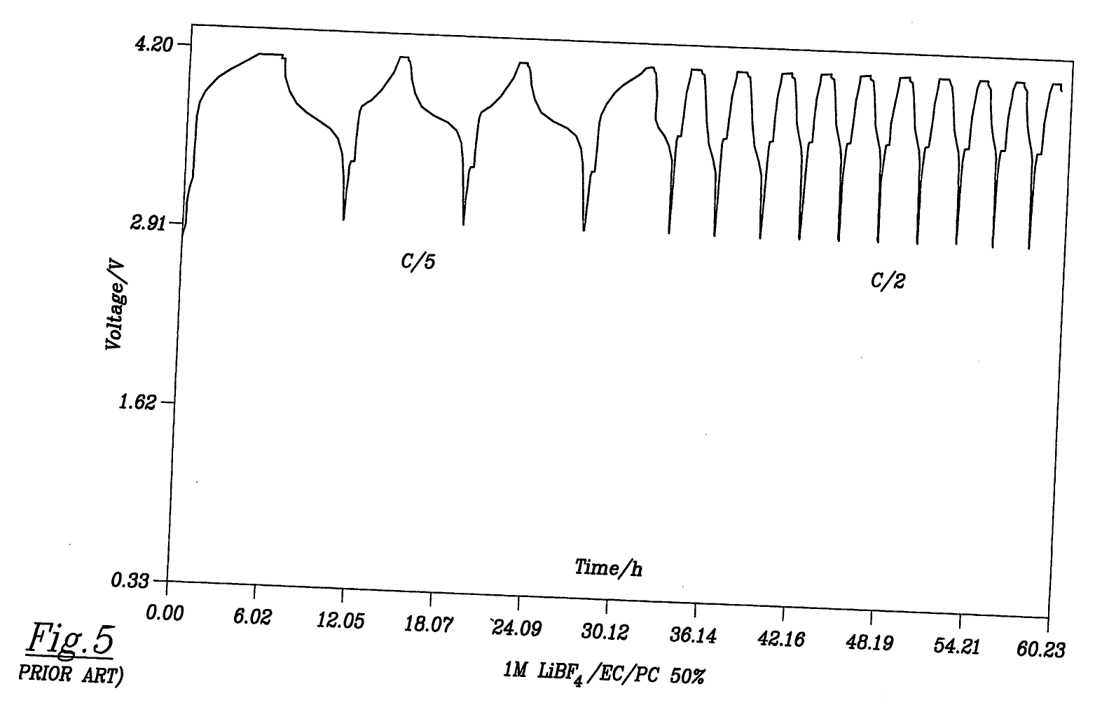

The composition of FIGS. 4, 4A was 1.5 M LiBF₄ in EC/PC 20%, (or 4:1 ratio) in a lithium-ion electrochemical device with MCMB anode, and the results compared to the prior art electrolyte of FIG. 5, illustrated that it outperformed the prior art electrolyte composition of 1M LiBF₄/EC/PC 50% in cycle life, and in C/2 rate capability. (Flat tops of the peaks in the graph indicate high resistance=low conductivity). Both lithium-ion cells are identical and have MCMB anodes.

The described fire resistant electrolytes have very close performance (rate and cycle life) to the existing described flammable electrolytes of FIGS. 1 and 1A, and are useable in lithium-ion and lithium-ion-polymer rechargeable batteries, and pseudocapacitors with graphitic, or other carbon anodes.

It has also been discovered that the high boiling point solvent EC carries most of the ionic conductivity load, and is stable with the carbon anode, while the low percentage of high boiling point GBL or PC or BC keeps the EC in a liquid state, especially at low temperatures. The relatively high viscosity and thus lower conductivity of their mixtures, as well as the lower conductivity of the LiBF₄ salt can be overcome by the higher molar content of the salt, which creates more of the necessary ionic bridges. Hence the ability to use 1.5M to 2M. Prior art 1M LiBF₄ is not good enough in these viscous electrolytes. The LiBF₄ salt also has a low molecular weight as opposed to LiPF₆, or other known salts which makes 1.5 to 3M or more loading in the electrolyte possible, and which also helps to maintain the liquid state of the EC, even at low temperatures. We also have found that EC and LiBF₄ form a eutectic solution in this range. The LiBF₄ salt is temperature resistant and less sensitive to moisture, which are additional benefits of the electrolytes of the invention.

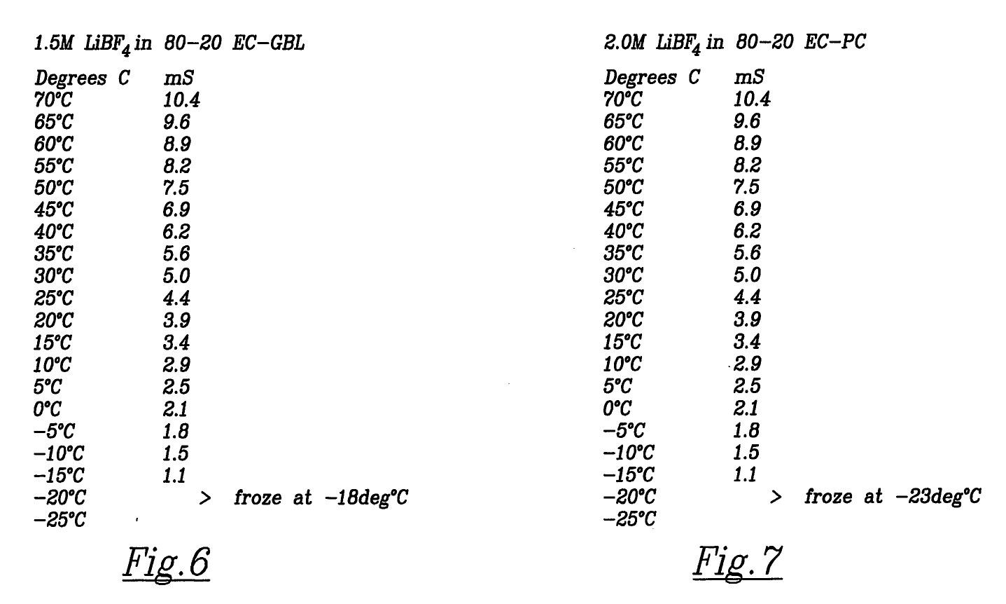

The above high boiling point liquids with LiBF₄ salt make the electrolytes fire resistant under normal atmospheric (air) conditions, and temperatures created by ignition with a match, or electrical spark, for example, which makes them safer in military and automotive applications. The useful range of LiBF₄ is 1.5M to 3M. The useful range of GBL, or PC, or BC is 10% to 30% by weight percent, and preferably 15% to 25% and more preferably approximately 20%. Operating temperature of the above electrolytes is from (−) 20° C. to (+) 150° C., and conductivities from 0.9 mS to 10.4 mS (at 70° C.) as shown in FIGS. 6 & 7. Similar mixtures as described above, but with 1M to 2.0 M LiPF₆ salt or other salts are useful, but less satisfactory. Also a combination of LiBF₄ and LiPF₆ or other salts in the range of 0.5M to 1.5M each, are useful. The above electrolytes are particularly useful with zero irreversible capacity loss cathodes, as described in our prior Pat. Appl. #PCT/US02/36878, which is incorporated herein by reference.

It will thus be seen that electrolyte compositions have been provided with which the objects of the invention are achieved.

We claim:

1. A fire resistant stable electrolyte composition for lithium-ion based electrochemical devices which comprises:
LiBF₄ salt in the range of 1.5 to 3.0 molar concentration in the mixture of ethylene carbonate in the range of 70 to 90% by weight percentage, and gamma-butyrolactone in the range of 10 to 30% by weight percentage.

2. A fire resistant stable electrolyte composition for lithium-ion based electrochemical devices which comprises:
LiBF₄ salt in the range of 1.5 to 3.0 molar concentration in the mixture of ethylene carbonate in the range of 70 to 90% by weight percentage, and propylene carbonate in the range of 10 to 30% by weight percentage.

3. A fire resistant stable electrolyte composition for lithium-ion based electrochemical devices which comprises:
LiBF₄ salt in the range of 1.5 to 3 molar concentration in the mixture of ethylene carbonate in the range of 70 to 90% by weight percentage, and butylene carbonate in the range of 10 to 30% by weight percentage.

4. A fire resistant stable electrolyte composition for lithium-ion based electrochemical devices which comprises:
two molar LiBF₄ salt concentration in the mixture of ethylene carbonate of 80% by weight percentage, and gamma-butyrolactone of 20% by weight percentage.

5. A fire resistant stable electrolyte composition for lithium-ion based electrochemical devices which comprises:
1.5 molar LiBF₄ salt concentration in the mixture of ethylene carbonate of 80% by weight percentage, and propylene carbonate of 20% by weight percentage.

6. A fire resistant stable electrolyte composition for lithium-ion batteries and other lithium based electrochemical devices which comprises:
1.5 molar LiBF₄ salt concentration in the mixture of ethylene carbonate of 80% by weight percentage, and butylene carbonate of 20% by weight percentage.

7. A fire resistant stable electrolyte composition for lithium-ion based electrochemical devices which comprises a mixture of electrolytes as described in claims 1, 2 and 3.

8. A fire resistant stable electrolyte composition for lithium-ion based
electrochemical devices which comprises a mixture of electrolytes as described in claims 4, 5 and 6.

9. A fire resistant stable electrolyte composition as described in claims 1 to 8 inclusive for lithium-ion based electrochemical devices in which said LiBF₄ salt is replaced by;
at least one other lithium salt in the range of 1.0 to 2.0 molar concentration.

10. A fire resistant stable electrolyte composition for lithium-ion based electrochemical devices which comprises:
LiBF₄ salt in the range of 1.5 to 3.0 molar concentration in approximately 100% ethylene carbonate.

11. A fire resistant stable electrolyte composition as described in claims 1-8 inclusive to which said LiBF₄ salt has at least one other lithium salt added thereto in the range of 0.5M to 1.5M.

12. A fire resistant stable electrolyte as described in claims 1-11 inclusive, in combination with lithium-ion based based electrochemical devices, which have a cathode with a lithium compound additive.
